(19) United States
(12) Patent Application Publication
(10) Pub. No.: US 2014/0318786 A1
(43) Pub. Date: Oct. 30, 2014

(54) COMPOSITIONS AND METHODS FOR SERVICING SUBTERRANEAN WELLS

(71) Applicant: Schlumberger Technology Corporation, Sugar Land, TX (US)

(72) Inventors: Konstantin Viktorovich Vidma, Novosibirsk (RU); Sergey Mikhailovich Makarychev-Mikhailo, St. Petersburg (RU); Anna Sergeyevna Mezdrokhina, Electrostal (RU); Vadim Kamil'evich Khlestkin, Novosibirsk (RU)

(21) Appl. No.: 14/366,717

(22) PCT Filed: Dec. 19, 2011
(86) PCT No.: PCT/RU2011/001002

§ 371 Date: Jul. 15, 2014

(51) Int. Cl. C09K 8/46; E21B 33/13

(52) U.S. Cl. CPC C09K 8/46; E21B 33/13
USPC 166/293; 523/130

(57) ABSTRACT

Subterreanean formations penetrated by a wellbore may be stimulated by injecting a well-treatment fluid at a rate and pressure sufficient to create and propagate a fracture in the formation. The treatment fluid comprises a first slurry comprising at least one inorganic cement, water and at least one disruptive agent that may cause the formation of open channels in the fracture through which hydrocarbons in the formation may flow into the wellbore. The disruptive agent may comprise (but would not be limited to) water-soluble polymers that cause flocculation and agglomeration of cement solids, expansive agents, explosive agents, degradable materials, or a combination thereof.

### BACKGROUND

The statements in this section merely provide background information related to the present disclosure and may not constitute prior art.

Hydrocarbons (oil, natural gas, etc.) are obtained from a subterranean geologic formation (i.e., a “reservoir”) by drilling a well that penetrates the hydrocarbon-bearing formation. This provides a partial flowpath for the hydrocarbon to reach the surface. In order for the hydrocarbon to be “produced,” that is travel from the formation to the wellbore (and ultimately to the surface), there must be a sufficiently unimpeded flowpath from the formation to the wellbore.

Various methods are known for fracturing a subterranean formation to create such a flowpath and enhance the production of fluids therefrom. In the typical application, a pressurized fracturing fluid hydraulically creates and propagates a fracture. The fracturing fluid carries proppant particles into the extending fracture. When the fracturing fluid is removed, the fracture does not completely close from the loss of hydraulic pressure; instead, the fracture remains propped open by the packed proppant, allowing fluids to flow from the formation through the proppant pack to the production wellbore.

The success of the fracturing treatment may depend on the ability of fluids to flow from the formation through the proppant pack. In other words, the proppant pack or matrix must have a high permeability relative to the formation to allow fluid to flow with low resistance to the wellbore. Furthermore, to retain fluid permeability for optimal flow from the formation into the fracture and the proppant pack, the surface regions of the fracture should not be significantly damaged during fracturing.

Since the advent of hydraulic fracturing, the oil and gas industry has worked to develop proppants and fracturing fluids that produce optimal propped fractures. As a result, the chemical and physical nature of these materials has changed significantly over time. Proppants have evolved from raw materials such as nut shells, to naturally occurring sands and to high-strength spheres manufactured, for example, from ceramics or bauxite. Fracturing fluids progressed from gelled oils to linear- and/or crosslinked-polymer solutions. Chemical breakers were introduced to decompose the polymer, reduce the amount of polymer residue in the fracture and/or improve conductivity. Eventually, residue-free fluids based on viscoelastic surfactants were developed, and the resulting permeability of proppant packs approached a theoretical limit.

Having essentially maximized proppant-pack conductivity, the industry began to investigate ways to further improve hydraulic-fracturing results.

One approach involves pumping alternating stages of proppant-laden and proppant-free fracturing fluids to create proppant clusters, or islands, in the fracture and channels between them for formation fluids to flow. See for example, “Channel Fracturing—A Paradigm Shift in Tight Gas Stimulation,” paper SPE 140549, presented at the SPE Hydraulic Fracturing Technology Conference and Exhibition, The Woodlands, Texas, USA, Jan. 24-26, 2011.

Despite the valuable contributions of the prior art, there are situations in which proppant is in short supply or is unavailable in sizes appropriate for a particular treatment. Such situations may occur, for example, in remote areas.

### SUMMARY

The present disclosure describes compositions and methods by which fractures may be propped by a discontinuous matrix that does not contain proppant.

In an aspect, embodiments relate to methods for stimulating a subterranean formation penetrated by a wellbore comprising: injecting into the wellbore a well-treatment fluid at a rate and pressure sufficient to create and propagate a fracture in the formation, wherein the treatment fluid comprises a first slurry comprising: at least one inorganic cement; water; and at least one disruptive agent.

In a further aspect, embodiments relate to methods for treating a subterranean formation penetrated by a wellbore, comprising: injecting into the wellbore a well-treatment fluid at a rate and pressure sufficient to create and propagate a fracture in the formation, wherein the treatment fluid comprises a first slurry comprising: at least one inorganic cement; water; and at least one disruptive agent; and allowing the slurry to set and harden.

In yet a further aspect, embodiments relate to methods for creating a discontinuous set-cement matrix comprising open channels therein comprising: preparing a mixture comprising at least one inorganic cement; water; and at least one disruptive agent and allowing the mixture to set and harden.

This summary is provided to introduce a selection of concepts that are further described below in the detailed description. This summary is not intended to identify key or essential features of the claimed subject matter, nor is it intended to be used as an aid in limiting the scope of the claimed subject matter.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the preferred embodiments and should not be construed as a limitation to the scope and applicability of the disclosed embodiments. While the compositions of the present disclosure are described herein as comprising certain materials, it should be understood that the composition could optionally comprise two or more chemically different materials. In addition, the composition can also comprise some components other than the ones already cited.

In the following disclosure, the term aggregate and/or aggregation encompass also flocculate and/or flocculation, coagulate and/or coagulation, agglomerate and/or agglomeration and may be used indifferently.

The Applicants have determined that aqueous well treatment fluids comprising an inorganic cement and a disruptive agent may be applied to form a discontinuous matrix in a hydraulic fracture. With such an approach, no proppant may be necessary.

Embodiments relate to methods for stimulating a subterranean formation penetrated by a wellbore. A well-treatment fluid comprising a first slurry comprising at least one inorganic cement, water and a disruptive agent is injected into the wellbore at a rate and pressure sufficient to create and propagate a fracture in the formation.

The inorganic cement may comprise (but would not be limited to) Portland cement, calcium aluminate cement, fly ash, blast furnace slag, lime/silica blends, magnesium oxychloride, chemically bonded phosphate ceramics, zeolites or geopolymers, and combinations thereof.

The cement is present in lieu of proppant; thus, for those skilled in the art, it is preferable to employ the standard proppant-concentration convention whereby one states the mass of proppant added to each unit volume of fluid. The customary unit is pounds per gallon added, or ppa. One ppa means that one pound of proppant is added to each gallon of fluid (in this case water). This unit is not to be confused with the more familiar lbm/gal. At present, there is no recognized SI-unit equivalent for ppa. For the embodiments presented in this disclosure, the cement concentration is preferably lower than about 24 ppa, and more preferably between about 1 ppa and about 20 ppa, or between about 8 ppa and about 20 ppa.

The disruptive agent in the treatment fluid may comprise one or more water-soluble polymers. Suitable polymers may comprise (but would not be limited to) natural hydratable polymers such as guar gum and derivatives thereof, locust bean gum, tara, konjak, tamarind, starch, cellulose and derivatives thereof, karaya, xanthan, tragacanth and carrageenan; and/or synthetic hydratible polymers and copolymers such as polyacrylate, polymethacrylate, polyacrylamide, maleic anhydride, methylvinyl ether polymers, polyvinyl alcohol or polyvinylpyrrolidone and mixtures thereof. Preferred disruptive agent may be polyacrylamide, polyacrylamide copolymers, guar gum and mixtures thereof The polymer concentration in the treatment fluid is preferably between about 0.01% and 10% by weight, more preferably between about 0.01% and about 5%, even more preferably between about 0.01% and about 0.5% by weight, and most preferably between about 0.02% and 0.1% by weight. The polymer molecular weight is preferably between about 300,000 Da and 15,000,000 Da, and more preferably between about 500,000 Da and 2,000,000 Da. The disruptive agent may further comprise an alkaline chloride salt, or an alkaline-earth chloride salt, or both. The chloride-salt concentration in the treatment fluid is preferably between about 10 kg/m3 and 1440 kg/m3, and more preferably between about 10 kg/m3 and about 100 kg/m3. Without wishing to be bound by any theory, the inventors believe that adding the water-soluble polymer may cause the slurry to aggregate, thereby creating open channels.

The disruptive agent in the treatment fluid may comprise an expansive agent, or an explosive agent, or both. Suitable expansive agents may comprise (but would not be limited to) magnesium oxide, calcium oxide, magnesium sulfate, iron (III) oxide, or calcium sulfoaluminate, and mixtures thereof. The expansive-agent concentration is preferably between about 0.5% and 10.0% by weight of cement, and more preferably between about 1.0% and 5.0% by weight of cement. The explosive agent may be an explosive chemical, a gas-generating agent, or a compressed gas, and combinations thereof. Suitable explosive chemicals may comprise (but would not be limited to) those which comprise a functional group selected from the list consisting of —NO2, —ONO2 and —NHNO2. The gas-generating agent may release hydrogen, and may comprise one or more metals from the list comprising aluminum, calcium, zinc, iron, magnesium, lithium, sodium or potassium, and mixtures thereof. The gas-generating agent may release nitrogen, and may comprise one or more members of the list comprising azodicarbonamide, sodium azodicarboxylate, azobismethyl propionitrite or p-toluenesulfonhydrazide, and mixtures thereof. Without wishing to be bound by any theory, the inventors believe that expansion of the cement slurry, detonation of the explosive agent, gas release or a combination thereof may cause the formation of cracks or open channels.

The disruptive agent in the treatment fluid may comprise one or more degradable materials. Suitable degradable materials may comprise (but would not be limited to) dissolvable materials such as polyvinyl alcohol (PVOH), salt, wax, calcium carbonate; and/or acid-generating dissolvable materials such as polylactic acid (PLA), polyglycolic acid (PGA), carboxylic acid, lactide, glycolide, copolymers of PLA or PGA, and the like and combinations thereof; and/or the degradable material may be formed of, or contain, a fluoride source capable of generating hydrofluoric acid upon release of fluorine and adequate protonation. Some non-limiting examples of fluoride sources which are effective for generating hydrofluoric acid include fluoboric acid, ammonium fluoride, ammonium fluoride, and the like, or any mixtures thereof. Preferred degradable materials are polylactic acid, polyglycolic acid, polyester, rock salts or paraffin wax, and combinations thereof. The degradable-material concentration is preferably between about 5% and about 95% by volume of treatment fluid, and more preferably between about 10% and about 50% by volume of treatment fluid. Without wishing to be bound by any theory, the inventors believe that degradation by hydrolysis (for polylactic acid, polyglycolic acid and polyester), solubilisation (rock salts), or melting (for paraffin wax) will cause the formation of open channels.

Embodiments relate to methods for treating a subterranean formation penetrated by a wellbore. A well-treatment fluid comprising a first slurry comprising at least one inorganic cement, water and a disruptive agent is injected into the wellbore at a rate and pressure sufficient to create and propagate a fracture in the formation.

The inorganic cement may comprise (but would not be limited to) Portland cement, calcium aluminate cement, fly ash, blast furnace slag, lime/silica blends, magnesium oxychloride, chemically bonded phosphate ceramics, zeolites or geopolymers, and combinations thereof.

The disruptive agent in the treatment fluid may comprise one or more water-soluble polymers. Suitable polymers may comprise (but would not be limited to) natural hydratable polymers such as guar gum and derivatives thereof, locust bean gum, tara, konjak, tamarind, starch, cellulose and derivatives thereof, karaya, xanthan, tragacanth and carrageenan; and/or synthetic hydratible polymers and copolymers such as polyacrylate, polymethacrylate, polyacrylamide, maleic anhydride, methylvinyl ether polymers, polyvinyl alcohol or polyvinylpyrrolidone and mixtures thereof. Preferred disruptive agent may be polyacrylamide, polyacrylamide copolymers, guar gum and mixtures thereof. The polymer concentration in the treatment fluid is preferably between about 0.01% and 10% by weight, more preferably between about 0.01% and about 5%, even more preferably between about 0.01% and about 0.5% by weight, and most preferably between about 0.02% and 0.1% by weight. The polymer molecular weight is preferably between about 300,000 Da and 15,000,000 Da, and more preferably between about 500,000 Da and 2,000,000 Da. The disruptive agent may further comprise an alkaline chloride salt, or an alkaline-earth chloride salt, or both. The chloride-salt concentration in the treatment fluid is preferably between about 10 kg/m3 and 1440 kg/m3, and more preferably between about 10 kg/m3 and about 100 kg/m3. Without wishing to be bound by any theory, the inventors believe that adding the water-soluble polymer may cause the slurry to aggregate, thereby creating open channels.

The disruptive agent in the treatment fluid may comprise an expansive agent, or an explosive agent, or both. Suitable expansive agents may comprise (but would not be limited to) magnesium oxide, calcium oxide, magnesium sulfate, iron (III) oxide, or calcium sulfoaluminate, and mixtures thereof The expansive-agent concentration is preferably between about 0.5% and 10.0% by weight of cement, and more preferably between about 1.0% and 5.0% by weight of cement. The explosive agent may be an explosive chemical, a gas-generating agent, or a compressed gas, and combinations thereof Suitable explosive chemicals may comprise (but would not be limited to) those which comprise a functional group selected from the list consisting of —NO2, —ONO2 and —NHNO2. The gas-generating agent may release hydrogen, and may comprise one or more metals from the list comprising aluminum, calcium, zinc, iron, magnesium, lithium, sodium or potassium, and combinations thereof. The gas-generating agent may release nitrogen, and may comprise one or more members of the list comprising azodicarbonamide, sodium azodicarboxylate, azobismethyl propionitrite or p-toluenesulfonhydrazide, and combinations thereof. Without wishing to be bound by any theory, the inventors believe that expansion of the cement slurry, detonation of the explosive agent, gas release or a combination thereof may cause the formation of cracks or open channels.

The disruptive agent in the treatment fluid may comprise one or more degradable materials. Suitable degradable materials may comprise (but would not be limited to) dissolvable materials such as polyvinyl alcohol (PVOH), salt, wax, calcium carbonate; and/or acid-generating dissolvable materials such as polylactic acid (PLA), polyglycolic acid (PGA), carboxylic acid, lactide, glycolide, copolymers of PLA or PGA, and the like and combinations thereof; and/or the degradable material may be formed of, or contain, a fluoride source capable of generating hydrofluoric acid upon release of fluorine and adequate protonation. Some non-limiting examples of fluoride sources which are effective for generating hydrofluoric acid include fluoboric acid, ammonium fluoride, ammonium fluoride, and the like, or any mixtures thereof. Preferred degradable materials are polylactic acid, polyglycolic acid, polyester, rock salts or paraffin wax, or combinations thereof. The degradable-material concentration is preferably between about 5% and about 95% by volume of treatment fluid, and more preferably between about 10% and about 50% by volume of treatment fluid. Without wishing to be bound by any theory, the inventors believe that degradation by hydrolysis (for polylactic acid, polyglycolic acid and polyester), solubilisation (rock salts), or melting (for paraffin wax) will cause the formation of open channels.

Embodiments relate to methods for creating a discontinuous set-cement matrix comprising open channels. A well-treatment fluid comprising a first slurry comprising at least one inorganic cement, water and a disruptive agent is injected into the wellbore at a rate and pressure sufficient to create and propagate a fracture in the formation.

The inorganic cement may comprise (but would not be limited to) Portland cement, calcium aluminate cement, fly ash, blast furnace slag, lime/silica blends, magnesium oxychloride, chemically bonded phosphate ceramics, zeolites or geopolymers, or combinations thereof.

The disruptive agent in the treatment fluid may comprise one or more water-soluble polymers. Suitable polymers may comprise (but would not be limited to) natural hydratable polymers such as guar gum and derivatives thereof, locust bean gum, tara, konjak, tamarind, starch, cellulose and derivatives thereof, karaya, xanthan, tragacanth and carrageenan; and/or synthetic hydratible polymers and copolymers such as polyacrylate, polymethacrylate, polyacrylamide, maleic anhydride, methylvinyl ether polymers, polyvinyl alcohol or polyvinylpyrrolidone and mixtures thereof. Preferred disruptive agent may be polyacrylamide, polyacrylamide copolymers, guar gum and mixtures thereof. The polymer concentration in the treatment fluid is preferably between about 0.01% and 10% by weight, more preferably between about 0.01% and about 5%, even more preferably between about 0.01% and about 0.5% by weight, and most preferably between about 0.02% and 0.1% by weight. The polymer molecular weight is preferably between about 300,000 Da and 15,000,000 Da, and more preferably between about 500,000 Da and 2,000,000 Da. The disruptive agent may further comprise an alkaline chloride salt, or an alkaline-earth chloride salt, or both. The chloride-salt concentration in the treatment fluid is preferably between about 10 kg/m3 and 1440 kg/m3, and more preferably between about 10 kg/m3 and about 100 kg/m3. Without wishing to be bound by any theory, the inventors believe that adding the water-soluble polymer may cause the slurry to aggregate, thereby creating open channels.

The disruptive agent in the treatment fluid may comprise an expansive agent, or an explosive agent, or both. Suitable expansive agents may comprise (but would not be limited to) magnesium oxide, calcium oxide, magnesium sulfate, iron (III) oxide, or calcium sulfoaluminate, and mixtures thereof. The expansive-agent concentration is preferably between about 0.5% and 10.0% by weight of cement, and more preferably between about 1.0% and 5.0% by weight of cement. The explosive agent may be an explosive chemical, a gas-generating agent, or a compressed gas, and combinations thereof. Suitable explosive chemicals may comprise (but would not be limited to) those which comprise a functional group selected from the list consisting of —NO2, —ONO2 and —NHNO2. The gas-generating agent may release hydrogen, and may comprise one or more metals from the list comprising aluminum, calcium, zinc, iron, magnesium, lithium, sodium or potassium, and combinations thereof. The gas-generating agent may release nitrogen, and may comprise one or more members of the list comprising azodicarbonamide, sodium azodicarboxylate, azobismethyl propionitrite or p-toluenesulfonhydrazide, and combinations thereof. Without wishing to be bound by any theory, the inventors believe that expansion of the cement slurry, detonation of the explosive agent, gas release or a combination thereof may cause the formation of cracks or open channels.

The disruptive agent in the treatment fluid may comprise one or more degradable materials. Suitable degradable materials may comprise (but would not be limited to) dissolvable materials such as polyvinyl alcohol (PVOH), salt, wax, calcium carbonate; and/or acid-generating dissolvable materials such as polylactic acid (PLA), polyglycolic acid (PGA), carboxylic acid, lactide, glycolide, copolymers of PLA or PGA, and the like and combinations thereof; and/or the degradable material may be formed of, or contain, a fluoride source capable of generating hydrofluoric acid upon release of fluorine and adequate protonation. Some non-limiting examples of fluoride sources which are effective for generating hydrofluoric acid include fluoboric acid, ammonium fluoride, ammonium fluoride, and the like, or any mixtures thereof. Preferred degradable materials are polylactic acid, polyglycolic acid, polyester, rock salts or paraffin wax, and combinations thereof. The degradable-material concentration is preferably between about 5% and about 95% by volume of treatment fluid, and more preferably between about 10% and about 50% by volume of treatment fluid. Without wishing to be bound by any theory, the inventors believe that degradation by hydrolysis (for polylactic acid, polyglycolic acid and polyester), solubilisation (rock salts), or melting (for paraffin wax) will cause the formation of open channels.

In all embodiments, multi-stage pumping may be envisaged. For example the cement slurry may contain alternatively high concentration of disruptive agent for a certain period of time and then lower concentration. These alternate sequences may further improve the channeling through the cement matrix.

### EXAMPLE

The following example serves to further illustrate the disclosure.

Four treatment fluids were prepared, and each was placed in a different Petri dish.

The protocol was as follows:
Solution of polymer in deionized water was prepared in a blender. All additives (CaCl2 or NaCl or both if applicable) were added at this stage as well;
40 ml of polymer solution were poured into the Petri dish;
Cement powder was added into the polymer solution (into the Petri dish) and was mixed manually with a spatula to homogenize the mixture;
Petri dishes with samples were then left for 24 hours at room temperature;
After 24 hours samples were visually inspected.

The first treatment fluid contained deionized water with Portland cement at a concentration of 1 ppa and cationic polyacrylamide at a concentration of 0.25 g/L (cationic polyacrylamide, from Nalco Chemical Company (Chicago, IL)): aggregation was observed the aggregate were relatively large (300 to 500 nm). The second treatment fluid was similar to the first, except that calcium chloride was also added at a concentration of 10 g/L. The third treatment fluid was similar to the first, except that sodium chloride was added at a concentration of 50 g/L. The fourth treatment fluid was similar to the first, except that calcium chloride was added at a concentration of 10 g/L and sodium chloride was added at a concentration of 50 g/L. Aggregation and agglomeration of the cement particles was observed in the second, third and fourth treatment fluids and with a larger size than in the first example (1500-2000 μm).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. A method for stimulating a subterranean formation penetrated by a wellbore, comprising: injecting into the wellbore a well-treatment fluid at a rate and pressure sufficient to create and propagate a fracture in the formation, wherein the treatment fluid comprises a first slurry comprising:
(a) at least one inorganic cement;
(b) water; and
(c) at least one disruptive agent.

2. The method of claim 1, wherein the cement concentration in the well-treatment fluid is lower than about 24 ppa.

3. The method of claim 1, wherein the disruptive agent comprises one or more water-soluble polymers, the polymers forming aggregates, thereby forming open channels in the slurry.

4. The method of claim 3, wherein the water-soluble polymer comprises guar gum and derivatives thereof, locust bean gum, tara, konjak, tamarind, starch, cellulose and derivatives thereof, karaya, xanthan, tragacanth and carrageenan; polyacrylate, polymethacrylate, polyacrylamide, maleic anhydride, methylvinyl ether polymers, polyvinyl alcohol or polyvinylpyrrolidone and mixtures thereof.

5. The method of claim 3, wherein the water-soluble-polymer concentration is between 0.01 and 10% percent by weight.

6. The method of claim 3, wherein the disruptive agent further comprises an alkaline chloride salt, or an alkaline-earth chloride salt, and combinations thereof.

7. The method of claim 6, wherein the chloride-salt concentration in the treatment fluid is between 10 kg/m³ and 1440 kg/m³.

8. The method of claim 1, wherein the disruptive agent comprises an expansive agent, or an explosive agent, or both.

9. The method of claim 8, wherein the expansive agent comprises magnesium oxide, calcium oxide, magnesium sulfate, iron (III) oxide, or calcium sulfoaluminate, and mixtures thereof.

10. The method of claim 8, wherein the expansive-agent concentration is between 0.5 and 10.0 percent by weight of cement.

11. The method of claim 8, wherein the explosive agent comprises an explosive chemical, a compressed gas, or a gas-generating agent, and combinations thereof

12. The method of claim 8, wherein the explosive-agent comprises a functional group selected from the list consisting of: —NO₂, —ONO₂ and —NHNO₂.

13. The method of claim 1, wherein the disruptive agent comprises at least one degradable material.

14. The method of claim 13, wherein the degradable material comprises polyvinyl alcohol (PVOH), salt, wax, calcium carbonate, polylactic acid (PLA), polyglycolic acid (PGA), carboxylic acid, lactide, glycolide, copolymers of PLA or PGA, and the like, a fluoride source capable of generating hydrofluoric acid upon release of fluorine and adequate protonation, or any mixtures thereof.

15. The method of claim 13, wherein the degradable-material concentration is between 5% and 95% by volume of treatment fluid.

16. The method of claim 1, wherein the disruptive agent comprises polyacrylamide, polyacrylamide copolymers, guar gum and mixtures thereof.

17. A method for treating a subterranean formation penetrated by a wellbore, comprising:
(i) injecting into the wellbore a well-treatment fluid at a rate and pressure sufficient to create and propagate a fracture in the formation, wherein the treatment fluid comprises a first slurry comprising:
(a) at least one inorganic cement;
(b) water; and
(c) at least one disruptive agent; and
(ii) allowing the slurry to set and harden.

18. The method of claim 17, wherein the disruptive agent comprises:
(i) an alkaline chloride, or an alkaline-earth chloride, or both, and one or more water-soluble polymers; and/or
(ii) an expansive agent, or an explosive agent, or both; and/or
(iii) at least one degradable material.

19. A method for creating a discontinuous set-cement matrix comprising open channels therein, comprising:
(i) preparing a mixture comprising
(a) at least one inorganic cement;
(b) water; and
(c) at least one disruptive agent
(ii) allowing the mixture to set and harden.

20. The method of claim 19, wherein the disruptive agent comprises:
(i) an alkaline chloride, or an alkaline-earth chloride, or both, and one or more water-soluble polymers; and/or
(ii) an expansive agent, or an explosive agent, or both; and/or
(iii) at least one degradable material.
